(19) United States
(12) Patent Application Publication
(10) Pub. No.: US 2018/0091719 A1
(43) Pub. Date: Mar. 29, 2018

(54) BACKLIGHT CORRECTION PROGRAM AND SEMICONDUCTOR DEVICE

(71) Applicant: Renesas Electronics Corporation, Tokyo (JP)

(72) Inventor: Hideki WAKISAKA, Tokyo (JP)

(73) Assignee: Renesas Electronics Corporation, Tokyo (JP)

(21) Appl. No.: 15/678,447

(22) Filed: Aug. 16, 2017

(30) Foreign Application Priority Data
Sep. 28, 2016 (JP) 2016-189272

(51) Int. Cl. H04N 5/235; H04N 5/355

(52) U.S. Cl. CPC H04N 5/2352; H04N 5/35572; H04N 5/2351

(57) ABSTRACT

In a related-art backlight correction process, an exposure time needs to be controlled, thus causing a problem for those who do not manufacture lenses and sensors on their own that it is difficult to implement the backlight correction process. According to one embodiment, a backlight correction process is performed by detecting a backlight state based on luminance information indicating a luminance distribution of an image extracted from pixel information constituting one image obtained from an image pickup device, calculating a correction setting value for correcting the backlight state of the image based on the luminance information and, correcting a backlight state of image information generated from the pixel information based on the calculated correction setting value.

### CROSS-REFERENCE TO RELATED APPLICATIONS

This application is based upon and claims the benefit of priority from Japanese patent application No. 2016-189272, filed on Sep. 28, 2016, the disclosure of which is incorporated herein in its entirety by reference.

### BACKGROUND

The present disclosure relates to a backlight correction program and a semiconductor device, and for example to a backlight correction program and a semiconductor device for performing a backlight correction for an output image generated based on pixel information obtained from an image sensor.

In recent years, it is required that a camera system should acquire an image with high clarity regardless of the state of the light under which a subject is photographed. An example of a cause for deteriorating the clarity of an image is a backlight state. In the backlight state, since the luminance of a part of an image is extremely higher than that of other parts, a blocked-up shadow occurs in a part of the image. Therefore, there is a backlight correction technique in which a correction process is performed for an image in the above-described backlight state to improve the clarity of the image Japanese Unexamined Patent Application Publication No. 2004-88545 discloses an example of the backlight correction technique.

A backlight correction technique disclosed in in Japanese Unexamined Patent Application Publication No. 2004-88545 includes: first means for dividing an shooting area of a video signal obtained by shooting a subject into a plurality of areas and detecting brightness for each of the divided shooting areas; second means for selecting a predetermined shooting area from among the plurality of divided shooting areas and detecting a brightness signal inside the selected shooting area and a brightness signal outside the shooting area; means for calculating a ratio between the brightness inside the shooting area and that outside the shooting area detected by the second means, or a difference between contrasts thereof; and means for adjusting an amount of exposure (hereinafter referred to as an “exposure amount”) for an image pickup apparatus based on the brightness inside the selected shooting area when it is determined that the image is in a backlight state based on a result obtained by the calculation mean.

### SUMMARY

The present inventors have found the following problem. To use the backlight correction method disclosed in Japanese Unexamined Patent Application Publication No. 2004-88545, it is necessary to adjust an exposure control method according to the characteristics of lenses and an image pickup device. However, in the case of a manufacturer in which a camera system is constructed by individually combining lenses, an image pickup device, and control circuits for these components, it is necessary to design a program for controlling exposure after comprehending the characteristic of each individual component, thus requiring a number of man-hours for crating the program. Further, when a lens or an image pickup device is changed, it is necessary to create a new program for controlling exposure again. Further, depending on matching between the characteristics of the lens and the image pickup device, there are cases in which a backlight correction cannot be made by simply adjustment the exposure amount. Because of the above-described circumstances, for manufacturers of camera systems in which lenses or image pickup devices are supplied from parts manufactures, there is a problem that a backlight correction process according to a backlight correction method using exposure control involves a number of difficulties.

Other objects and novel features will be more apparent from the following description in the specification and the accompanying drawings.

According to one embodiment, a backlight correction program and a semiconductor device include: detecting a backlight state based on luminance information indicating a luminance distribution of an image extracted from information of pixels constituting an image corresponding to one picture (hereinafter simply referred to as “one image”) acquired from an image pickup device; calculating a correction setting value for correcting the backlight state of the image based on the luminance information; and correcting a backlight state of image information generated from the information of pixels based on the calculated correction setting value.

According to the above-described embodiment, it is possible to correct a backlight state of output image information without controlling the exposure amount.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram of a camera system including an image pickup device according to a first embodiment;

FIG. 2 is a block diagram of a semiconductor device according to the first embodiment;

FIG. 3 is a block diagram of a gamma control unit according to the first embodiment;

FIG. 4 is a flowchart showing an operation of the semiconductor device according to the first embodiment;

FIG. 5 shows pictures and graphs for explaining an aspect of a backlight correction in the semiconductor device according to the first embodiment;

FIG. 6 is a diagram for explaining a software structure in the camera system according to the first embodiment;

FIG. 7 is a block diagram of a semiconductor device according to a second embodiment; and

FIG. 8 is a block diagram of a semiconductor device according to a third embodiment.

### DETAILED DESCRIPTION

For clarifying the explanation, the following descriptions and the drawings may be partially omitted and simplified as appropriate. Further, each of the elements that are shown in the drawings as functional blocks for performing various processes can be implemented by hardware such as a CPU, a memory, and other types of circuits, or implemented by software such as a program loaded in a memory. Therefore, those skilled in the art will understand that these functional blocks can be implemented solely by hardware, solely by software, or a combination thereof. That is, they are limited to neither hardware nor software. Note that the same symbols are assigned to the same components throughout the drawings and duplicated explanations are omitted as required.

Further, the above-described program can be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Read Only Memory), a CD-R, and a CD-R/W, and a semiconductor memory (such as a mask ROM, a PROM (Programmable ROM), an EPROM (Erasable PROM), a flash ROM, and a RAM (Random Access Memory)). Further, the program can be supplied to computers by using various types of transitory computer readable media. Examples of the transitory computer readable media include an electrical signal, an optical signal, and an electromagnetic wave. The transitory computer readable media can be used to supply programs to computer through a wire communication path such as an electrical wire and an optical fiber, or wireless communication path.

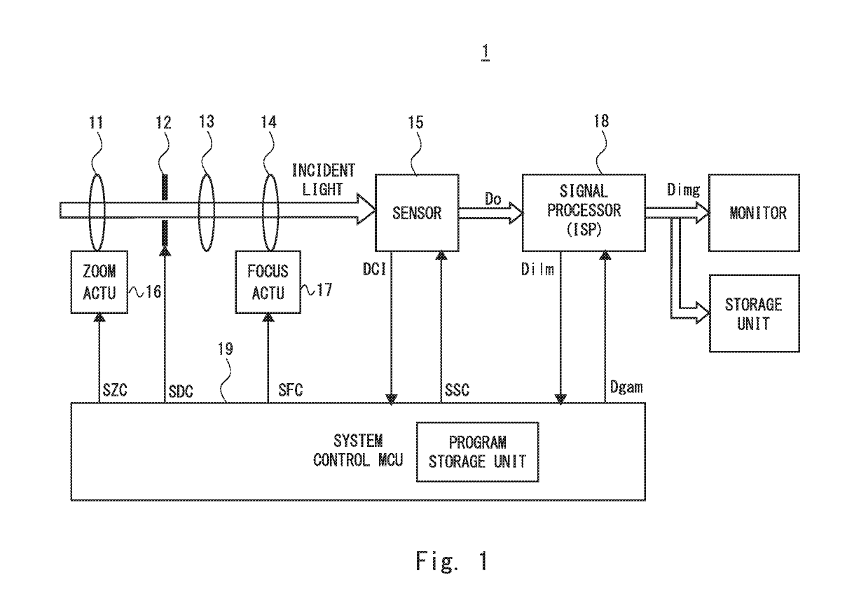

FIG. 1 is a block diagram of a camera system 1 according to a first embodiment. As shown in FIG. 1, the camera system 1 includes a zoom lens 11, a diaphragm mechanism (or an aperture mechanism) 12, a fixed lens 13, a focus lens 14, a sensor 15, a zoom lens actuator 16, a focus lens actuator 17, a signal processing circuit 18, a system control MCU 19, a monitor, and a storage device. Note that the monitor and the storage device are used to check and store an image shot by the camera system 1, and may be disposed in a separate system different from the camera system 1.

The zoom lens 11, the diaphragm mechanism 12, the fixed lens 13, and the focus lens 14 form a group of lenses (hereinafter referred to as a “lens group”) of the camera system 1. The position of the zoom lens 11 is changed by the zoom lens actuator 16. The position of the focus lens 14 is changed by the focus lens actuator 17. Further, in the camera system 1, a zooming magnification and a focus are changed by moving lenses by using various actuators and the amount of incident light is changed by operating the diaphragm mechanism 12.

The zoom lens actuator 16 moves the zoom lens 11 based on a zoom control signal SZC output by the system control MCU 19. The focus lens actuator 17 moves the focus lens 14 based on a focus control signal SFC output by the system The control MCU 19. The diaphragm mechanism 12 adjusts the aperture level according to a diaphragm control signal SDC output by the system control MCU 19.

The sensor 15, which corresponds to the image pickup device according to the first embodiment and includes, for example, light-receiving elements such photodiodes, converts light-receiving pixel information obtained from these light-receiving elements into digital values and outputs them as pixel information Do. Further, the sensor 15 analyzes the pixel information Do, which the sensor 15 outputs as described above, and outputs image feature information DCI representing a feature(s) of the pixel information Do. This image feature information DCI includes contrast information acquired in an autofocus process (which is described later). Further, the sensor 15 performs gain control for each pixel of the pixel information Do and exposure control for the pixel information Do based on a sensor control signal SSC supplied from a module control MCU 18. Details of the sensor 15 are described later.

The signal processing circuit 18 generates image information in accordance with a predetermined format from the pixel information Do received from the sensor 15, performs image processing such as a correction process for the generated image information, and outputs the resultant image information as image information Dimg. Further, the signal processing circuit 18 analyzes the received pixel information Do and outputs luminance information Dilm. The luminance information Dilm includes, for example, for the pixel information Do about pixels constituting one image, luminance information indicating a luminance level for each divided area that is obtained by dividing the area of the image into a plurality of areas.

The system control MCU 19 controls the focus of the lens group based on the image feature information DCI output from the sensor 15. More specifically, the system control MCU 19 controls the focus of the lens group by outputting a focus control signal SFC to the focus lens actuator 17. The system control MCU 19 adjusts the aperture level of the diaphragm mechanism 12 by outputting a diaphragm control signal SDC to the diaphragm mechanism 12. Further, the system control MCU 19 generates a zoom control signal SZC according to an externally-supplied zoom instruction and controls the zooming magnification of the lens group by outputting the zoom control signal SZC to the zoom lens actuator 16.

More specifically, the focus is shifted by moving the zoom lens 11 by using the zoom lens actuator 16. Therefore, the system control MCU 19 calculates an amount of defocus (hereinafter referred to as a “defocus amount”) of the lens group based on the contrast information (a contrast ratio between pixels to be compared) included in the image feature information DCI obtained from the sensor 15. The system control MCU 19 automatically obtains a correct focus according to this defocus amount. The above-described process is the autofocus control.

Further, the system control MCU 19 calculates a correction setting value Dgam for correcting a backlight state of the image information Ding based luminance information included in the luminance information Dilm output from the signal processing circuit 18. Then, the signal processing circuit 18 generates the image information Dimg by performing a backlight correction process for the pixel information Do based on the correction setting value Dgam calculated by the system control MCU 19. Note that the system control MCU 19 may also calculate a control value for the diaphragm mechanism 12 when it changes the exposure.

One of the features of the camera system 1 according to the first embodiment lies in that the signal processing circuit 18 and the system control MCU 19 correct the backlight state of the image information Dimg by using the pixel information Do output from the sensor 15 regardless of the state of the exposure control in the sensor 15. Therefore, the signal processing circuit 18 and the system control MCU 19 are explained hereinafter in a more detailed manner.

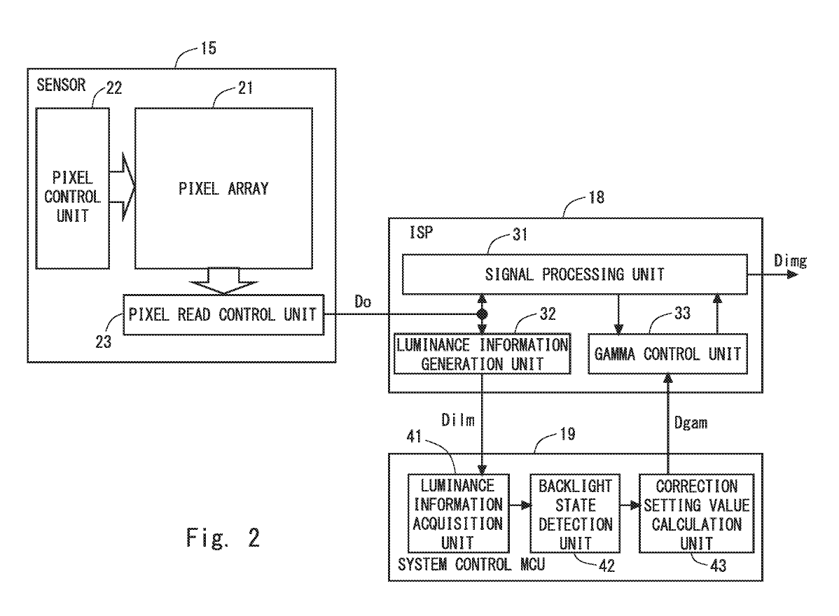

FIG. 2 is a block diagram of a semiconductor device according to the first embodiment. As shown in FIG. 2, a semiconductor device according to the first embodiment includes a plurality of semiconductor chips. In the example shown in FIG. 2, the system control MCU 19 is used as a first semiconductor chip and the signal processing processor 18 is used as a second semiconductor chip. Note that in FIG. 2, an image pickup device (e.g., the sensor 15) is used as a device that outputs pixel information Do used by the signal processing circuit 18 and the system control MCU 19.

For the pixel information Do constituting one image output from the sensor 15, the system control MCU 19 acquires luminance information Dilm indicating a luminance distribution of the pixel information Do for each divided area that is obtained by dividing the area of the image into a plurality of areas, calculates a correction setting value Dgam for correcting a blocked-up shadow in the image based on the acquired luminance information Dilm, and outputs the calculated correction setting value Dgam. The signal processing circuit 18 corrects a luminance level of image information Dimg generated from the pixel information Do based on the correction setting value Dgam and thereby generates image information Dimg that is ultimately output from the signal processing circuit 18 (hereinafter simply expressed as “image information Dimg to be ultimately output”). Further, the signal processing circuit 18 acquires pixel information Do constituting one image from the sensor 15, generates luminance information Dilm from the acquired pixel information Do, and outputs the generated luminance information Dilm to the system control MCU 19.

More specifically, in the semiconductor device according to first embodiment, the above-described backlight correction process is performed by a backlight correction program executed by the signal processing circuit 18 and the system control MCU 19. Note that in FIG. 2, each process in the backlight correction program is defined as one process block and the process block is represented by one block. Further, a part or all of the process blocks shown in FIG. 2 can be implemented by hardware.

The sensor 15 shown in FIG. 2 includes a pixel array 21, a pixel control unit 22, and a pixel read control unit 23. In the pixel array 21, light-receiving elements are arranged in a lattice pattern. Further, the pixel array 21 outputs pixel output signals having signal levels that are determined according to amounts of received light. The pixel control unit 22 performs exposure control for the light-receiving elements arranged in the pixel array 21 and control for output timings of the pixel output signals. The pixel read control unit 23 generates pixel information. Do having a digital value according to the signal level of the pixel output signal output from the pixel array 21.

As shown in FIG. 2, the signal processing circuit 18 includes a signal processing unit 31, a luminance information generation unit 32, and a backlight correction unit (e.g., a gamma control unit 33). The signal processing unit 31 generates image information Dimg according to a predetermined format from the pixel information Do acquired from the sensor 15. Further, the signal processing circuit 18 performs, before generating the image information Dimg, a correct on process for the image information Dimg generated from the pixel information Do by using the gamma control unit 33.

The luminance information generation unit 32 acquires pixel information Do constituting one image from the sensor 15 and performs a luminance information generation process for generating luminance information from the acquired pixel information Do. Note that the luminance information generated by the luminance information generation unit 32 indicates a luminance distribution of the pixel information Do for each divided area obtained by dividing the image into a plurality of areas.

The gamma control unit 33 performs a specified gamma correction process (e.g., a gamma correction process for a monitor) for correct ng a luminance level of the image information Dimg, which is generated from the pixel information Do, in accordance with a specified setting value (e.g., a characteristic of a monitor in which the image is displayed) and performs a gamma correction process for a backlight correction (hereinafter referred to as a “backlight-correction gamma correction process”) for correcting a backlight state. In this backlight-correction gamma correction process, the gamma control unit 33 corrects the luminance level of the image information Dimg generated from the pixel information Do based on the correction setting value Dgam calculated by the system control MCU 19 and thereby generates image information Dimg to be ultimately output.

The system control MCU 19 includes a luminance information acquisition unit 41, a backlight state detection unit 42, and a correction setting value calculation unit 43. The luminance information acquisition unit 41 acquires luminance information Dilm generated by the luminance information generation unit 32. For example, the luminance information acquisition unit 41 includes a memory and stores luminance information Dilm acquired from the luminance information generation unit 32 into this memory.

The backlight state detection unit 42 verifies the luminance information Dilm stored is the luminance information acquisition unit 41, and detects a backlight state of an image (i.e., detects that a backlight state occurs in an image) when a difference between the luminance of at least one divided area and that of another divided area is larger than a predetermined value defined in advance.

When a backlight state is detected, the correction setting value calculation unit 43 calculates a correction setting value Dgam for changing the luminance level of the image information Dimg that is output for the corresponding pixel information Do acquired from the sensor 15. Note that the correction setting value Dgam includes a gamma curve indicating a correspondence relation between the luminance level of the pixel information Do and the luminance level of the image information Dimg.

Although the luminance information generation unit 32 is disposed in the signal processing circuit 18 in the example shown in FIG. 2, the luminance information generation unit 32 can be disposed in the sensor 15. In such a case, the luminance information acquisition unit 41 acquires the luminance information Dilm from the sensor 15.

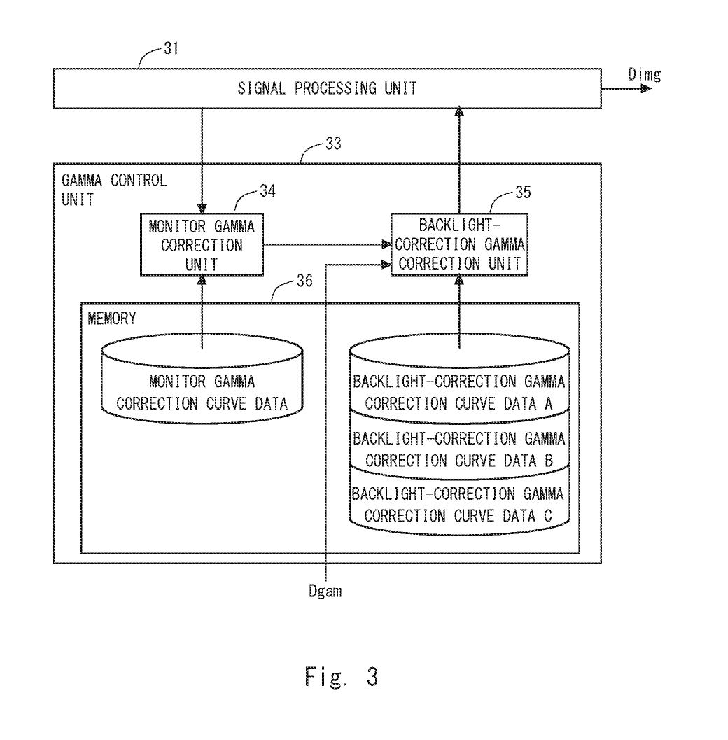

It should be noted that the gamma control unit 33 according to the first embodiment performs two gamma correction processes. The gamma control unit 33 is explained hereinafter in a more detailed manner. Therefore, FIG. 3 shows a block diagram of the gamma control unit according to the first embodiment. Note that the signal processing unit 31 is also shown in FIG. 3 to illustrate input/output signals of the gamma control unit 33.

As shown in FIG. 3, the gamma control unit 33 includes a gamma correction unit for a monitor (hereinafter referred to as a “monitor gamma correction unit”) 34, a gamma correction unit for a backlight correction (hereinafter referred to as a “backlight-correction gamma correction unit”) 35, and a memory 36. The monitor gamma correction unit 34 is, for example, a processing unit that performs a specified gamma correction process. The monitor gamma correction unit 34 corrects a luminance level of image information Dimg, which is generated from the pixel information Do, based on specified gamma correction data determined in advance (e.g., gamma correction curve data for a monitor) even when no backlight state is detected.

The backlight-correction gamma correction unit 35 recognizes the presence/absence of a backlight state and its strength based on the correction setting value Dgam output from the system control MCU 19. When a backlight state is detected, the backlight-correction gamma correction unit 35 reads gamma correction curve data for a backlight correction corresponding to the strength of the backlight state from the memory 36. Further, the backlight-correction gamma correction unit 35 performs an additional luminance correction process for the pixel information Do, for which the monitor gamma correction unit 34 has performed the correction process, based on the read gamma correction curve data and outputs the resultant image information to the signal processing unit 31.

The memory 36 stores therein gamma correction curve data for a monitor (hereinafter referred to as “monitor gamma correction curve data”) and gamma correction curve data for a backlight correction (hereinafter referred to as “backlight-correction gamma correction curve data”) A to C. The monitor gamma correction curve data is specified gamma correction data that is applied to the pixel information Do irrespective of whether or not a backlight state is detected. Each of the backlight-correction gamma correction curve data A to C is gamma correction curve data that is applied to the pixel information. Do when a backlight state is detected. For example, the backlight-correction gamma correction curve data A is gamma correction curve data that is applied when the intensity of light (hereinafter referred to as “light intensity”) causing the backlight state is high. The backlight-correction gamma correction curve data B is gamma correction curve data that is applied when the light intensity causing the backlight state is in an intermediate level. The backlight-correction gamma correction curve data C is gamma correction curve data that is applied when the light intensity causing the backlight state is low.

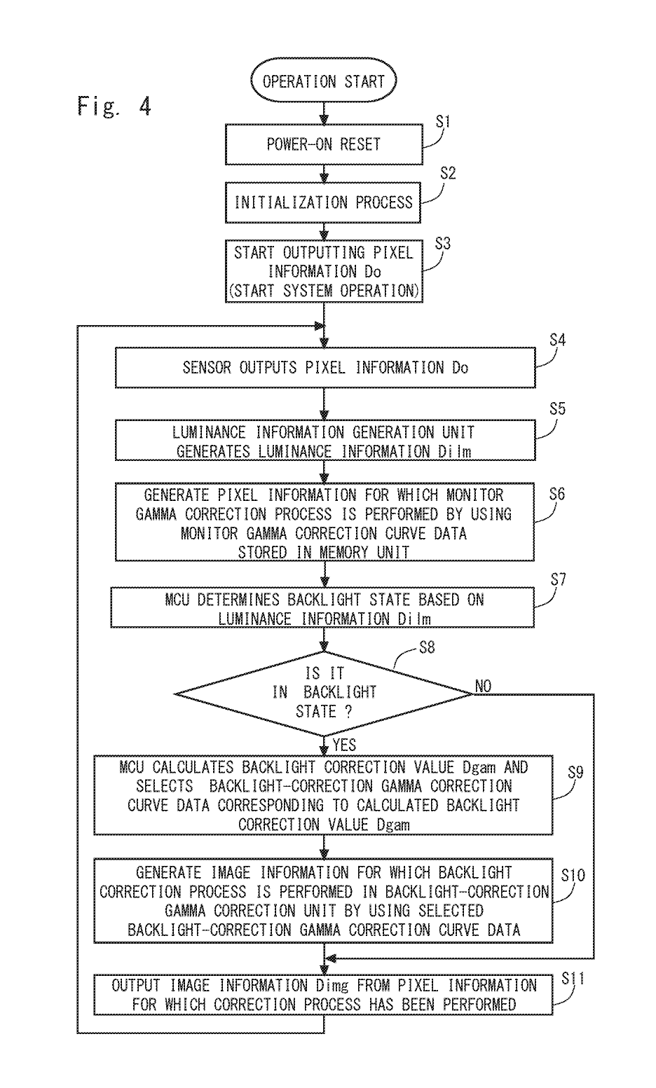

Next, an operation of the semiconductor device according to the first embodiment is explained. Therefore, FIG. 4 is a flowchart showing an operation of the semiconductor device according to the first embodiment. As shown in FIG. 4, when the semiconductor device according to the first embodiment starts its operation, it initializes the states of the sensor 15, the signal processing circuit 18, and the system control MCU 19 by performing a power-on reset process (step S1).

Next, the semiconductor device according to the first embodiment performs an initialization process (step S2). In this initialization process, the semiconductor device sets operation setting values for the sensor 15, the signal processing circuit 18, and the system control MCU 19 in an operation start state based on pre-defined setting values. After that, the semiconductor device according to the first embodiment starts its operation and the sensor 15 starts outputting pixel information Do (step S3).

Next, in the semiconductor device according to the first embodiment, the sensor 15 outputs pixel information Do (step S4). The luminance information generation unit 32 acquires the pixel information Do output from the sensor 15 in the step S4 and generates luminance information Dilm (step S5). Further, in the semiconductor device according to the first embodiment, the gamma control unit 33 generates pixel information for which the monitor gamma correction unit 34 has performed a monitor gamma correction process by using the monitor gamma correction curve data stored in the memory 36 (step S6).

Next, in the semiconductor device according to the first embodiment, the luminance information acquisition unit 41 of the system control MCU 19 acquires the luminance information Dilm from the luminance information generation unit 32. Then, the backlight state detection unit 42 of the system control MCU 19 determines whether the image is in a backlight state based on the luminance information Dilm stored in the luminance information acquisition unit 41 (step S7). In this step S7, the backlight state detection unit 42 verifies a luminance distribution for each divided area of the image, and determines that the image is in a backlight state and hence detects the backlight state of the image when a difference between the luminance of at least one divided area and that of another divided area is larger than a predetermined value defined in advance.

Then, when the backlight state detection unit 42 determines that the image is not in a backlight state (No at step S8), the correction setting value calculation unit 43 outputs a pre-defined correction setting value Dgam (i.e., a value indicating that no backlight state is detected, e.g., a predetermined memory address that does not exist). Further, in the semiconductor device according to the first embodiment, the backlight-correction gamma correction unit 35 provides the pixel information generated by the monitor gamma correction unit 34 to the signal processing unit 31 as it is without performing a correction process, and the signal processing unit 31 generates image information Dimg from the provided pixel information and outputs the generated image information Dimg (step S11). In the semiconductor device according to the first embodiment, processes in steps S4 to S8 are performed after the step S11.

On the other hand, when the backlight state detection unit 42 determines that the image is in a backlight state (Yes at step S8), the correction setting value calculation unit 43 calculates a correction setting value Dgam for correcting the backlight state (e.g., a memory address at which backlight-correction correction curve data corresponding to the light intensity causing the backlight state) and outputs the calculated correction setting value Dgam to the gamma control unit 33. Then, the backlight-correction gamma correction unit 35 selects backlight-correction gamma correction curve data based on the provided correction setting value Dgam (step S9). Further, the signal processing unit 31 generates new pixel information by further performing a correction process for a backlight correction for the pixel information, for which the monitor gamma correction unit 34 has performed the correction process, based on the backlight-correction gamma correction curve data selected by the backlight-correction gamma correction unit 35 (step S10). After that, in the semiconductor device according to the first embodiment, the pixel information, for which the backlight-correction gamma correction unit 35 has performed the correction process, is provided to the signal processing unit 31. Then, the signal processing unit 31 generates image information Dimg from the provided pixel information and outputs the generated image information Dimg (step S11). In the semiconductor device according to the first embodiment, processes in steps S4 to S8 are performed after the step S11.

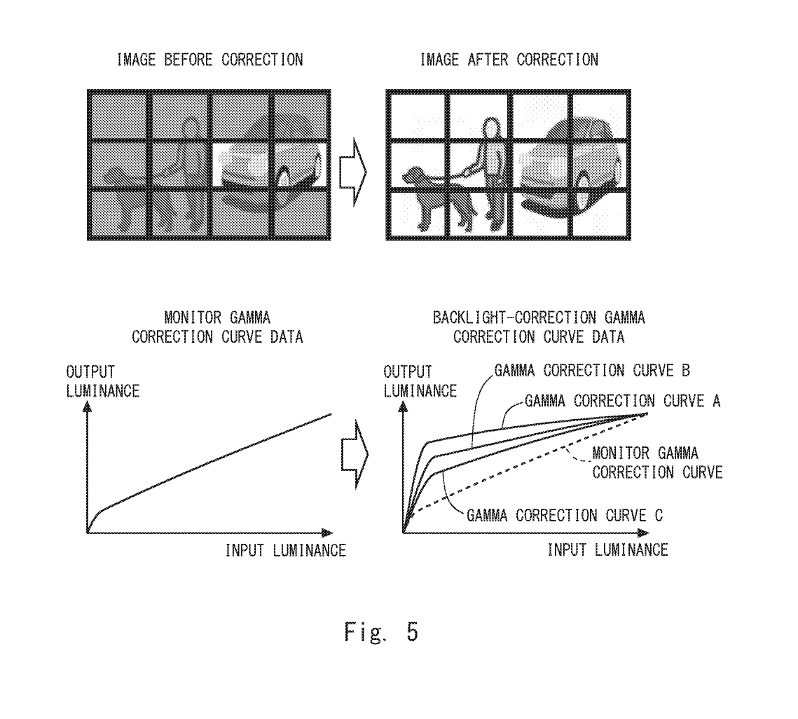

A backlight correction process performed in the semiconductor device according to the first embodiment is explained hereinafter in a more detailed manner. Therefore, FIG. 5 shows pictures and graphs for explaining an aspect of a backlight correction in the semiconductor device according to the first embodiment. In the example shown in FIG. 5, there are a car and a person is in an image, in which a backlight state occurs due to headlights of the car. In this case, the luminance of an area near the headlights of the car is high and the luminance of other parts is low. Further, there is a difference equal to or larger than a predetermined value between the luminance level of the high-luminance area having and that of the low-luminance area. In this case, the backlight state detection unit 42 determines that a backlight state occurs in the image. Then, the correction setting value calculation unit 43 corrects a gamma curve indicating a correspondence relation between the luminance level of the input pixel information Do and the luminance level of the output image information Dimg. Specifically, the correction setting value calculation unit 43 corrects the gamma curve so that the luminance level of the image information Dimg that is generated based on the pixel information Do on the low-luminance side in the input pixel information Do becomes higher than that of the image information Dimg that is generated based on the gamma curve for which the correction has not been made yet.

Further, in the semiconductor device according to the first embodiment, gamma correction curves are prepared for respective light intensities that cause backlight states. This is because as the light intensity causing a backlight state increases, an area having low light intensity becomes darker and hence the clarity deteriorates. More specifically, in the semiconductor device according to the first embodiment, backlight-correction gamma correction curves are created in such a manner that the higher the light intensity causing a backlight state is, the more the correction strength for an area having a low luminance level is increased. By performing the above-described correction, it is possible to make the person and the car clearer in the corrected image.

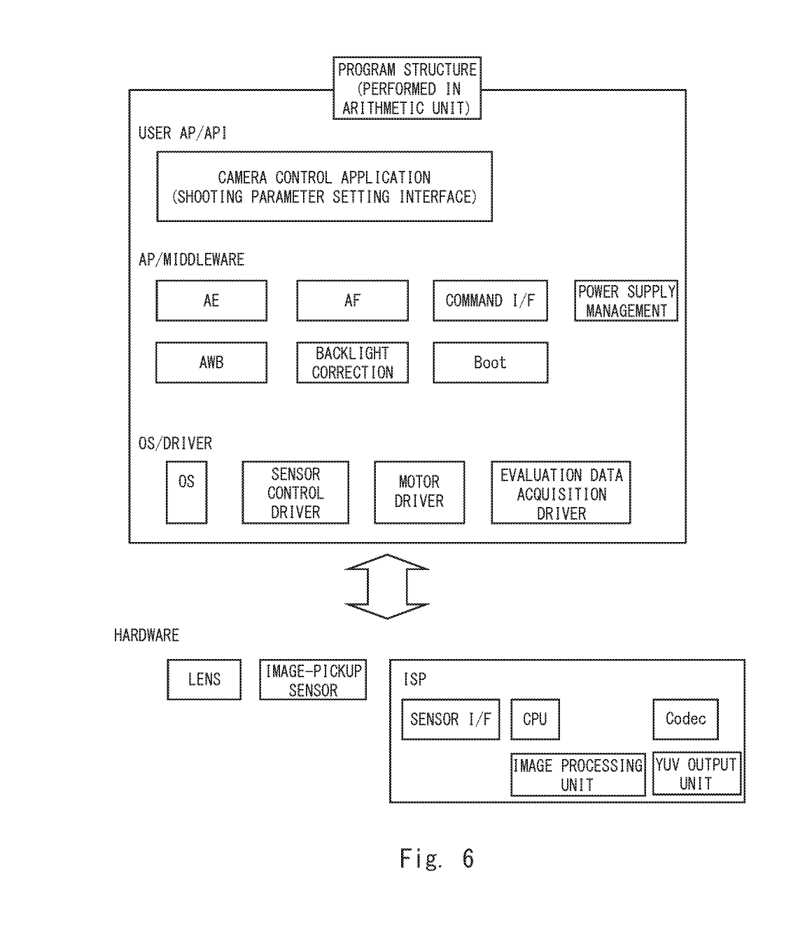

Next, a structure of a program that is executed in the signal processing circuit 18 and the system control MCU 19 is explained. Therefore, FIG. 6 is a diagram for explaining a structure of program in the camera system 1 according to the first embodiment. As shown in FIG. 6, in the example of the structure of the program executed in the camera system 1, an OS, a sensor control driver, a motor drive, an evaluation data acquisition driver, and so on are included as software in an OS/driver layer. The OS is fundamental software for operating (or executing) software such as drives and middleware. The sensor control driver is software for performing fundamental control of the sensor 15. The motor driver is software for controlling a motor for driving a lens and the like of the camera system 1. The evaluation data acquisition driver is software for receiving pixel information Do from the sensor 15 and evaluating quality such as a luminance distribution in the signal processing circuit 18.

Further, as software in an AP/middleware layer, the program includes auto-exposure (AE) control software, autofocus (AF) control software, command interface software, power supply management software, auto-white-balance (AWB) control software, backlight correction software, booting control software, and so on. The auto-exposure control software is software for controlling a diaphragm (or an aperture) in an optical mechanism of the camera system 1 or an exposure time of the sensor 15. The autofocus control software is control software for moving a lens of the camera system 1 and thereby adjusting a focus for a subject. The command interface software is software for mediating commands transmitted/received between software modules. The power supply management software is software for managing power supply of the camera system 1. The auto-white-balance control software is software for adjusting a white balance of image information. Dimg by controlling the signal processing circuit 18. The backlight correction software is software for performing the backlight correction process performed in the luminance information acquisition unit 41, the backlight state detection unit 42, the correction setting value calculation unit 43, and the gamma control unit 33. The booting software is software for performing a start-up process of the camera system.

Further, as software in a user AP/API layer, the program includes Web application software for providing a user interface and so on.

By adopting the software structure shown in FIG. 6, it is possible to add or delete a driver, middleware, or user software. Further, by adopting the software structure shown in FIG. 6, it is also possible to change a function of software. Examples of a conceivable change in a function of software include a change in a correction method in a backlight correction process.

As explained above, in the semiconductor device according to the first embodiment, a backlight state is detected based on a luminance distribution of pixel information Do obtained from the sensor 15 and a correction process is performed for the backlight state. In this way, in the semiconductor device according to the first embodiment, it is possible to output image information Dimg in which a backlight correction process has been performed without performing exposure control such as control for an exposure time of the sensor 15.

Further, by using the semiconductor device according to the first embodiment, it is possible to obtain image information Dimg in which a backlight correction process has been performed irrespective of the characteristics of the lens and the sensor 15. When a backlight correction is performed by using control of an exposure time, it is necessary to perform correction control in accordance with the characteristics of the lens and the sensor 15. Therefore, there is a problem that it is difficult to effectively use the backlight correction unless the characteristics of these components are thoroughly comprehended. However, by using the semiconductor device according to the first embodiment, it is possible to perform a backlight correction without taking the characteristics of the lens and the sensor 15 into consideration.

Further, by using the semiconductor device according to the first embodiment, there is no need to change the program for a backlight correction process even when the lens and the sensor 15 are changed (e.g., replaced) and hence there is no need to create a new program again which would otherwise be necessary due to the change in the components.

Further, the semiconductor device according to the first embodiment performs a backlight correction based on pixel information Do acquired from the sensor 15. Therefore, when an image acquired from the sensor 15 is in a backlight state, a backlight correction can be immediately performed for the image. In contrast to this, in the backlight correction using the exposure control, there is a problem that although it is possible to perform a backlight correction for an image for which a backlight state is already acquired, it is impossible to perform a backlight correction for an already-acquired image.

Further, the backlight correction process using the semiconductor device according to the first embodiment makes it possible to perform a backlight correction in real-time even when the pixel information Do is one of a plurality of images constituting moving images. Therefore, it is possible to maintain the clarity throughout the whole moving images without generating a frame in a backlight state.

### Second Embodiment

In a second embodiment, another embodiment of the semiconductor device according to the first embodiment is explained. Note that in the explanation of a semiconductor device according to the second embodiment, the same symbols as those in the first embodiment are assigned to the same components as those in the first embodiment and their explanations are omitted.

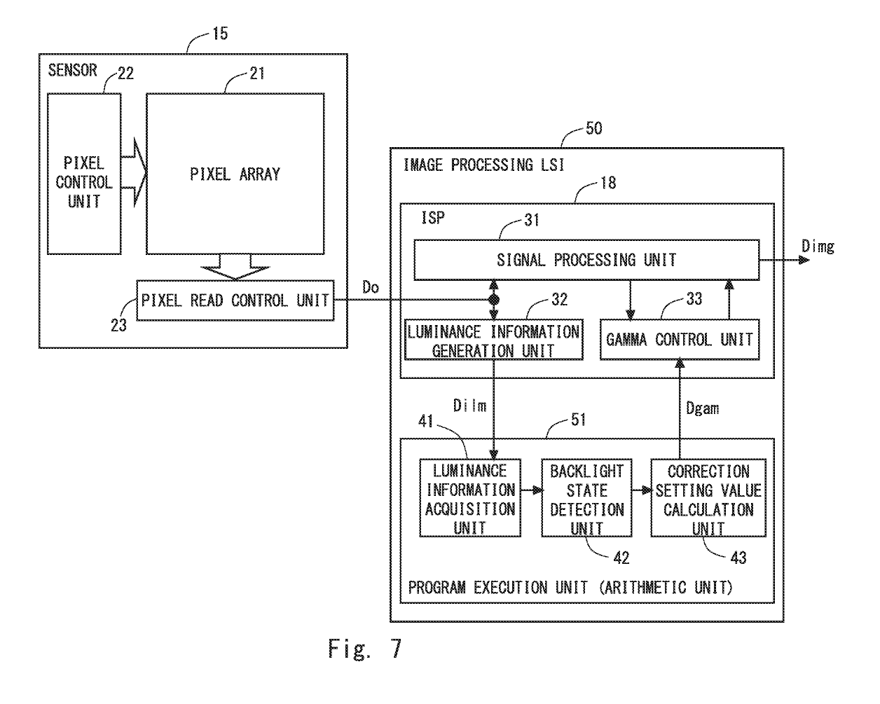

FIG. 7 is a block diagram of a semiconductor device according to the second embodiment. As shown in FIG. 7, the semiconductor device according to the second embodiment includes a signal processing LSI 50 in place of the signal processing circuit 18 and the system control MCU 19. Further, the signal processing LSI 50 includes a signal processing circuit 18 and an arithmetic unit (e.g., a program execution unit 51) disposed therein. Compared to the system control MCU 19, the program execution unit 51 has only functions corresponding to the functions of the luminance information acquisition unit 41, the backlight state detection unit 42, and the correction setting value calculation unit 43, or corresponding to the program execution function thereof.

The signal processing LSI 50 includes the signal processing circuit 18 and the program execution unit 51 as described above. These processing blocks may be formed on one semiconductor chip, or may be formed on two different semiconductor chips contained in one package.

In the semiconductor device according to the second embodiment, it is possible to reduce the area in which the semiconductor device is mounted by the signal processing circuit 18 and the program execution unit 51 in one package. Further, since the processing blocks for the backlight correction are disposed in one package, it is easy to implement (i.e., to create) software for the backlight correction.

### Third Embodiment

In a third embodiment, a sensor 15a, which is another embodiment of of the sensor 15 according to the first embodiment, is explained. Note that in the explanation of a semiconductor device according to the third embodiment, the same symbols as those in the first and second embodiments are assigned to the same components as those in the first and second embodiments and their explanations are omitted.

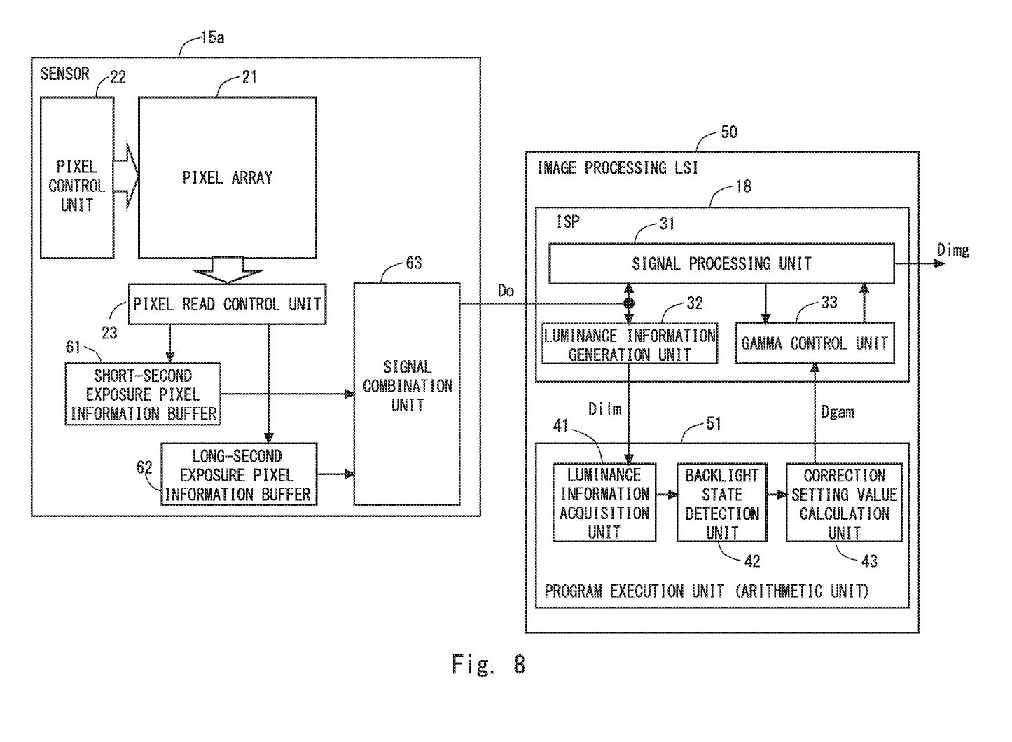

FIG. 8 is a block diagram a semiconductor device according to the third embodiment. As shown in FIG. 8, the semiconductor device according to the third embodiment includes a sensor 15a in place of the sensor 15. The sensor 15a generates low-luminance pixel information having high clarity in a low-luminance area and high-luminance pixel information having high clarity in a high-luminance area by using different exposure times, generates one image by combining the low-luminance pixel information with the high-luminance pixel information, and outputs pixel information constituting the generated one image.

The sensor 15a is obtained by adding a short-second exposure pixel information buffer 61, a long-second exposure pixel information buffer 62, and a signal combining unit 63 in the sensor 15. Further, the pixel control unit 22 and the pixel read control unit 23 in the sensor 15a successively perform exposure processes having different exposure times and output pixel information.

The short-second exposure pixel information buffer 61 holds high-luminance pixel information having high clarity in a high-luminance area, for which a shorter one of the different exposure times is used as the exposure time. The long-second exposure pixel information buffer 62 holds low-luminance pixel information having high clarity in a low-luminance area, for which a longer one of the different exposure times is used as the exposure time. The signal combining unit 63 generates one image by combining the high-luminance pixel information held in the short-second exposure pixel information buffer 61 with the low-luminance pixel information held in the long-second exposure pixel information buffer 62, and outputs pixel information constituting the generated one image. Specifically, the signal combining unit 63 outputs the low-luminance pixel information read from the long-second exposure pixel information buffer 62 as pixel information having luminance equal to or lower than a specified luminance threshold, and outputs the high-luminance pixel information read from the short-second exposure pixel information buffer 61 as pixel information having luminance higher than the luminance threshold.

That is, the sensor 15a outputs pixel information for generating an HDR (High Dynamic Range) image for which the dynamic range of an image in the sensor 15a is expanded from the dynamic range obtained from the light-receiving elements arranged in the pixel array 21.

When an image pickup device that outputs an HDR image by a combining process performed in a sensor as described above is used, a change in the exposure time affects the clarity of the HDR image when a backlight state is corrected by the control of the exposure time. Therefore, it is practically difficult to perform a backlight correction by using the exposure time.

However, by using the semiconductor device explained above in the first or second embodiment, it is possible, by using pixel information output as an HDR image, to perform a backlight correction process for an image in which an HDR combining process has been performed. As described above, when it is difficult to perform a backlight correction by using the exposure time, a backlight correction process performed by the semiconductor device explained above in the first or second embodiment provides an excellent advantageous effect.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

The first and second embodiments can be combined as desirable by one of ordinary skill in the art.

What is claimed is:

1. A non-transitory computer readable medium storing a backlight correction program executed in an image processing apparatus configured to output image information by performing signal processing for pixel information output by an image pickup device, the backlight correction program being configured to cause the image processing apparatus to execute:
a luminance information acquisition process of acquiring, for the pixel information constituting one image output from the image pickup device, luminance information indicating a luminance distribution of the pixel information for each divided area obtained by dividing an area of the image into a plurality of areas;
a backlight state detection process of verifying the luminance information, and detecting a backlight state of the image when a difference between luminance of at least one divided area and that of another divided area is larger than a predetermined value defined in advance;
a correction setting value calculation process of, when the backlight state is detected, calculating a correction setting value for changing a luminance level of the image information output for corresponding pixel information acquired from the image pickup device; and
a backlight correction process of correcting a luminance level of the image information generated from the pixel information based on the correction setting value and thereby generating the image information to be ultimately output.

2. The non-transitory computer readable medium storing a backlight correction program according to claim 1, wherein the backlight correction program is configured to cause the image processing apparatus to further execute a specified gamma correction process of correcting the luminance level of the image information generated from the pixel information based on specified gamma correction data determined in advance even when no backlight state is detected.

3. The non-transitory computer readable medium storing a backlight correction program according to claim 1, wherein the backlight correction program is configured to cause the image processing apparatus to further execute a luminance information generation process of acquiring the pixel information constituting one image from the image pickup device, and generating the luminance information from the acquired pixel information.

4. The non-transitory computer readable medium storing a backlight correction program according to claim 1, wherein the correction setting value includes a gamma curve indicating a correspondence relation between the luminance level of the pixel information and the luminance level of the image information.

5. The non-transitory computer readable medium storing a backlight correction program according to claim 1, wherein the image pickup device generates the one image by combining low-luminance pixel information having high clarity in a low-luminance area with high-luminance pixel information having high clarity in a high-luminance area, and outputs the pixel information constituting the generated image.

6. The non-transitory computer readable medium storing a backlight correction program according to claim 1, wherein the image processing apparatus performs each process of the backlight correction program in a plurality of semiconductor chips in a distributed manner.

7. A semiconductor device comprising a first semiconductor chip and a second semiconductor chip, wherein
the first semiconductor chip acquires, for pixel information constituting one image output from an image pickup device, luminance information indicating a luminance distribution of the pixel information for each divided area obtained by dividing an area of the image into a plurality of areas, calculates a correction setting value for correcting a blocked-up shadow in the image based on the acquired luminance information, and outputs the calculated correction setting value, and
the second semiconductor chip corrects a luminance level of image information generated from the pixel information based on the correction setting value and thereby generates the image information to be ultimately output.

8. The semi conductor device according to claim 7, wherein the second semiconductor chip further executes a specified gamma correction process of correcting the luminance level of the image information generated from the pixel information based on specified gamma correction data determined is advance even when no backlight state is detected.

9. The semiconductor device according to claim 7, wherein the second semiconductor chip further acquires the pixel information constituting one image from the image pickup device, generates the luminance information from the acquired pixel information, and outputs the generated luminance information to the first semiconductor chip.

10. A semiconductor device comprising:
a luminance information acquisition unit configured to acquire, for the pixel information constituting one image output from the image pickup device, luminance information indicating a luminance distribution of the pixel information for each divided area obtained by dividing an area of the image into a plurality of areas;
a backlight state detection unit configured to verify the luminance information, and detect a backlight state of the image when a difference between luminance of at least one divided area and that of another divided area is larger than a predetermined value defined in advance;
a correction setting value calculation unit configured to, when the backlight state is detected, calculate a correct on setting value for changing a luminance level of the image information output for corresponding pixel information acquired from the image pickup device; and
a backlight correction process unit configured to correct a luminance level of the image information generated from the pixel information based on the correction setting value and thereby generate the image information to be ultimately output.

11. The semiconductor device according to claim 10, further comprising a specified gamma correction unit configured to correct the luminance level of the image information generated from the pixel information based on specified gamma correction data determined in advance even when no backlight state is detected.

12. The semiconductor device according to claim 10, further comprising a luminance information generation unit configured to acquire the pixel information constituting one image from the image pickup device, and generate the luminance information from the acquired pixel information.

13. The semiconductor device according to claim 10, wherein the correction setting value includes a gamma curve indicating a correspondence relation between the luminance level of the pixel information and the luminance level of the image information.

14. The semiconductor device according to claim 10, wherein the image pickup device generates the one image by combining low-luminance pixel information having high clarity in a low-luminance area with high-luminance pixel information having high clarity in a high-luminance area, and outputs the pixel information constituting the generated image.

15. The semiconductor device according to claim 10, wherein at least one of the luminance information acquisition unit, the backlight state detection unit, the correction setting value calculation unit, and the backlight correction unit is formed on a semiconductor chip different from that on which other units are formed.
